(19) United States
(12) Patent Application Publication
(10) Pub. No.: US 2008/0095963 A1
(43) Pub. Date: Apr. 24, 2008

(54) SUPPLEMENTAL LABEL

(75) Inventor: Dave Robbins, Little Rock, AR (US)

Correspondence Address: LATHROP & GAGE LC, 2345 GRAND AVENUE, SUITE 2800, KANSAS CITY, MO, 64108, US

(73) Assignee: Vestcom New Century LLC

(21) Appl. No.: 11/671,737

(22) Filed: Feb. 6, 2007

(51) Int. Cl. B32B 33/00

(52) U.S. Cl. 428/40.1

(57) ABSTRACT

Supplemental labels and methods of manufacturing supplemental labels are disclosed herein. A supplemental label according to an embodiment includes a presentation portion having a front face and a coupling portion extending from the presentation portion and having opposed front and rear faces. The presentation portion front face includes indicia. Transparent adhesive is adhered to the coupling portion rear face to removably couple the coupling portion to an object. The presentation portion includes a first material, and first and second sheets of transparent laminate sandwich the first material and comprise the coupling portion.

### BACKGROUND

The present invention relates generally to labeling, and in particular to retail shelf labeling with printed labels having transparent sections and methods of making the same.

Printed labels comprise an important form of communication. Labels are commonly used for conveying information in a wide range of applications. In the retail sector, for example, labels are commonly applied to product displays (i.e., “point-of-sale” displays) to identify objects and to convey information about those objects to customers. Retail establishments may employ various types of labels to communicate such product information as pricing, product identification, etc.

In retail establishments, product information tends to be dynamic in that product offerings and pricing undergo frequent changes. Point-of-sale product labeling is often changed by applying new labels to shelves on which the products are displayed. Such shelf labeling is a significant part of the labeling activity in retail commercial establishments, and the frequent relabeling which occurs in many stores consumes significant labor resources.

Many prior art labels are adhesively attached to the shelf edges in a manner that requires excessive labor to remove the labels before being updated with replacements. Improvements have been made to these basic adhesive labels to reduce the bond between the labels and shelves through employing various types and amounts of adhesive. While these improved labels reduce the labor required to update the information, they are generally meant as replacements for the outdated labels and do not allow the consumers to view the prior product information unless that information is included on the new label. If an item is “on sale”, for example, the store owner may want the consumers to see the original price of the item. Additionally, barcode information and other static (unchanging) information has to be printed on each new label.

Another prior art labeling system is disclosed in U.S. Pat. No. 6,632,316. This system uses labels removably placed inside transparent label display strips to avoid the labor associated with removing labels that have been adhesively bonded to shelves. While outdated labels can be easily replaced by new labels in this system, the consumers still are not typically able to view the prior product information unless that information is included on the new label. Barcode information and other static information has to be printed on each new label.

One prior art label is made of paper and has a “window” covered by a transparent laminate (similar to many envelope windows). Two-sided transparent tape is then coupled to the transparent laminate so that the label may be attached to a store shelf and an underlying label can be seen through the window. While this addresses some of the problems noted above, the two-sided tape coupled with the laminate can make the underlying label difficult to see, the portion of the label surrounding the window requires undue attention in applying the label over the underlying label, and the portion of the label surrounding the window can make the underlying label difficult to see even if care is taken when applying the label. In addition, the manufacture of this label is unnecessarily complicated and expensive.

While a prior art flag is known that has a first end of clear film with adhesive and an opposed second end of paper or clear film without adhesive, the second end has predetermined printed material and this flag does not allow a user (e.g., a store manager) to customize the printed material. As such, the flag is of little use besides drawing attention to a product. The known prior art embodiment of this flag that has opposed ends of clear film is manufactured by printing on the clear film and adding adhesive to one of the ends. The known prior art embodiment of this flag that has one end of clear film and an opposed end of paper is manufactured by adding adhesive to the clear film and using the adhesive to attach the clear film to part of the paper. A removable backing material is then applied to the exposed adhesive. Due to the method of manufacture, a strip of the exposed adhesive approximately half a millimeter wide is often left uncovered by the backing. This uncovered adhesive can attract debris or be otherwise undesirable.

A supplemental label is needed that can be adhesively attached to a shelf, label display strip, or other suitable device so that the underlying label can be easily viewed through the supplemental label. Methods of manufacturing such supplemental labels are also needed.

### SUMMARY

A supplemental label according to an embodiment includes a presentation portion having a front face and a coupling portion extending from the presentation portion and having opposed front and rear faces. The presentation portion front face includes indicia. Transparent adhesive is adhered to the coupling portion rear face to removably couple the coupling portion to an object. The presentation portion includes a first material, and first and second sheets of transparent laminate sandwich the first material and comprise the coupling portion.

A method of manufacturing a supplemental label according to an embodiment includes the steps of providing a first material; providing a first sheet of laminate having an inner face with transparent adhesive and an outer face; providing a second sheet of laminate having an inner face with transparent adhesive and an outer face; completely encasing the first material between the first and second sheets of laminate, whereby the adhesive on the first sheet of laminate couples the first sheet of laminate to the first material and to the second sheet of laminate and whereby the adhesive on the second sheet of laminate couples the second sheet of laminate to the first material and to the first sheet of laminate; introducing a pattern of transparent adhesive to one of the first sheet of laminate outer face and the second sheet of laminate outer face; and removably coupling a backing to the pattern of transparent adhesive for selectively concealing the pattern of transparent adhesive.

A method of manufacturing a supplemental label according to an embodiment includes the steps of providing a first material; providing first and second sheets of laminate, each sheet of laminate having an inner face and an outer face; completely encasing the first material between the first and second sheets of laminate; coupling a portion of the first sheet of laminate extending beyond the first material to a corresponding portion of the second sheet of laminate extending beyond the first material to form a coupling portion; introducing a pattern of transparent adhesive to one of the first sheet of laminate outer face and the second sheet of laminate outer face at the coupling portion to selectively couple the first material, the first sheet of laminate, and the second sheet of laminate to an object; and removably coupling a backing to the pattern of transparent adhesive for selectively concealing the pattern of transparent adhesive.

### BRIEF DESCRIPTION OF THE DRAWINGS

FIG. 1 is a front perspective view of a supplemental label according to an embodiment.

FIG. 2 is a rear perspective view of the supplemental label of FIG. 1.

FIG. 3 is a slightly exploded side view of the supplemental label of FIG. 1.

FIG. 4 is a front perspective view of the supplemental label of FIG. 1 coupled to a shelf.

FIG. 5 is a front view of a sheet of the supplemental labels of FIG. 1 according to an embodiment.

FIG. 6 is an exploded view of FIG. 5.

FIG. 7 is a side view of FIG. 5.

FIG. 8 is a diagram representing a manufacturing process according to an embodiment for creating the supplemental label of FIG. 1.

### DETAILED DESCRIPTION

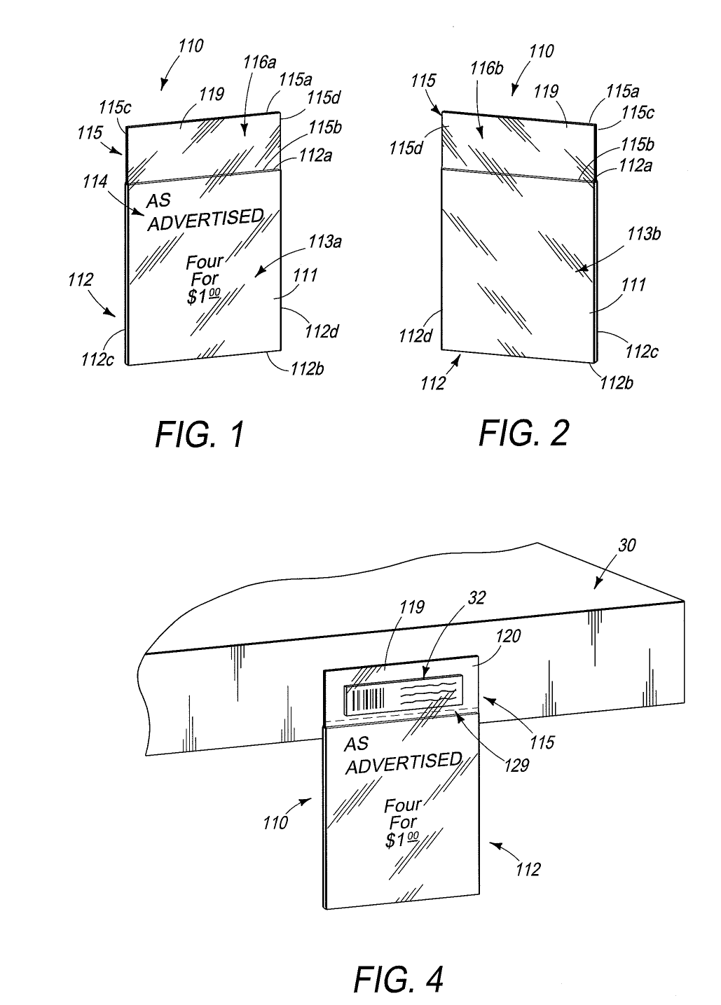

FIGS. 1 and 2 show a supplemental label 110 having a presentation portion 112 and a coupling portion 115. The presentation portion 112 has top and bottom ends 112a, 112b and opposed sides 112c, 112d. While the ends and sides 112a, 112b, 112c, 112d of the presentation portion 112 are shown to collectively be generally rectangular, non-rectangular configurations may alternately be defined.

The presentation portion 112 further includes a front face 113a (FIG. 1) and a rear face 113b (FIG. 2). The front face 113a may include indicia 114 that may be generic (e.g., “sale”) and/or specifically tailored. The presentation portion 112 is shown including a single layer of material 111 (e.g., paper, card stock, etc.), though additional layers may be included.

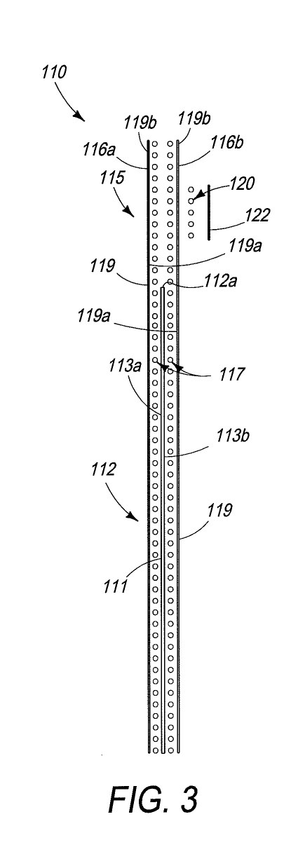

Two sheets of transparent laminate 119 are shown encasing the presentation portion 112 and defining the coupling portion 15 (FIG. 3). Each sheet of transparent laminate 119 has an inner face 119a, and each inner face 119a has an adhesive 117 (e.g., a transparent pressure-sensitive adhesive) that is used to couple the sheets of transparent laminate 119 to each other and the material 111. The coupling portion 115 is depicted to have top and bottom ends 115a, 115b and opposed sides 115c, 115d. While the ends and sides 115a, 115b, 115c, 115d of the coupling portion 115 are shown to collectively be generally rectangular and the coupling portion 115 is shown to have a width that is approximately equal to a width of the presentation portion 112, non-rectangular configurations and/or other widths may alternately be defined. As shown throughout the drawings, the coupling portion sides 115c, 115d may be unbounded beyond the presentation portion end 112a. In other words, it is not necessary to provide a border around the coupling portion sides 115c, 115d, though such a border may be used.

The coupling portion 115 has a front face 116a (FIG. 1) and a rear face 116b (FIG. 2), and the rear face 116b has adhesive 120 (i.e., a transparent pressure-sensitive adhesive) that may be used to couple the coupling portion 115 to an object. The adhesive 120 may entirely cover the coupling portion rear face 116b or may define a strip (or any appropriate configuration) that only partially covers the coupling portion rear face 116b. FIG. 4 shows the adhesive 120 coupling the coupling portion 115 to a store shelf 30 over another label 32. A liner or backing 122 having a release material (e.g., a silicone release, etc.) or otherwise being easily separable from adhesive bonds may be coupled to the adhesive 120 to selectively conceal and expose the adhesive 120, as shown in FIG. 3.

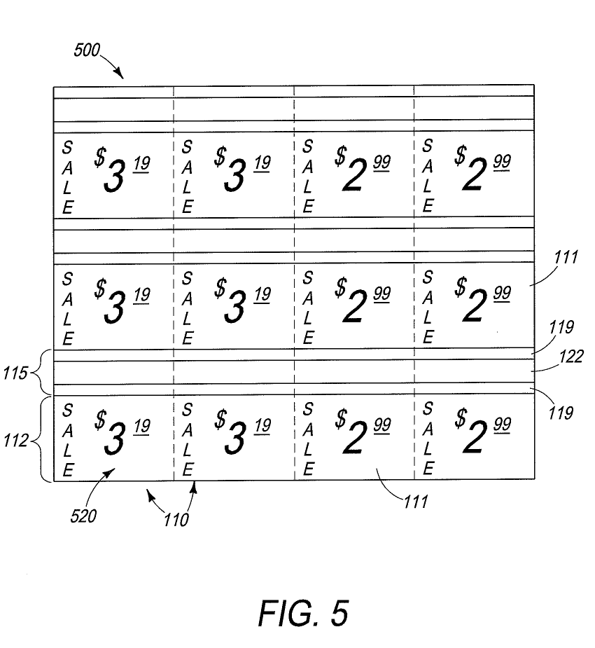

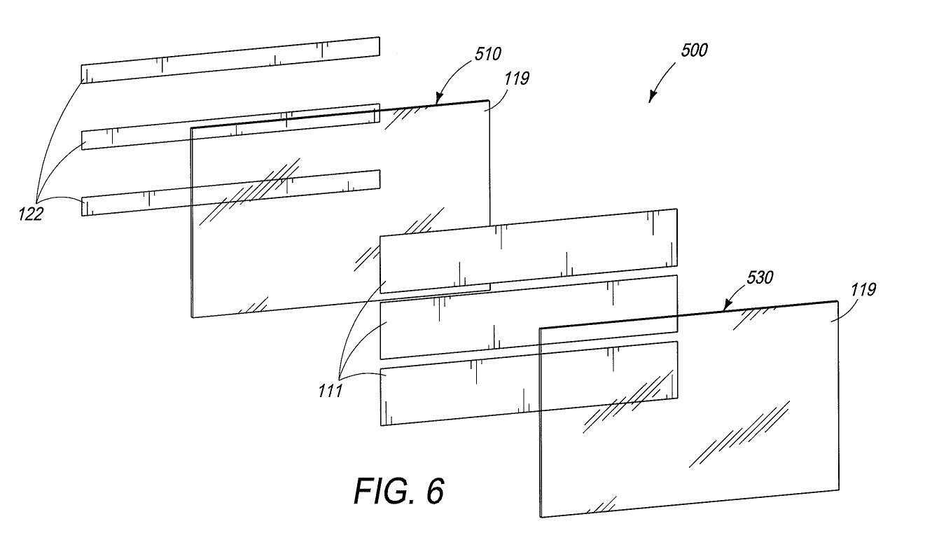

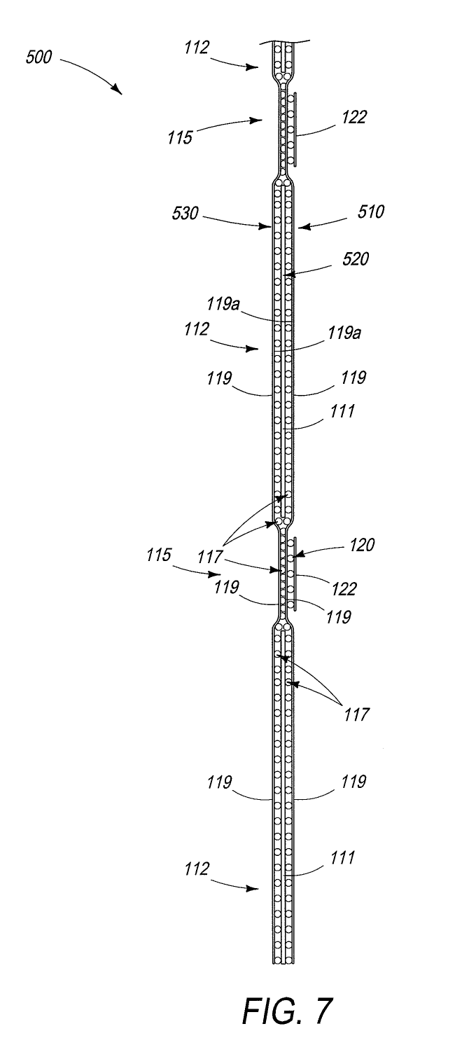

FIGS. 5 through 7 show a sheet 500 of the supplemental labels 110 according to an embodiment. The sheet 500 may be 8½ inches by 11 inches or any other appropriate size. The sheet 500 includes a first layer 510 of the transparent laminate 119. A sheet 520 of the material 111 (e.g., paper, card stock, etc.) is atop the first layer 510 of laminate 119 and is coupled to the laminate 119 by the adhesive 117 on the inner face 119a of the laminate 119. Multiple sheets 520 of the material 111 may be spaced along the first layer 510 of the laminate 119. A second layer 530 of the transparent laminate 119 is atop the sheet(s) 520 and the first layer 510 with the inner face 119a facing the first layer 510 and the sheet(s) 520. The second layer 530 is coupled to the first layer 510 and the sheet(s) 520 by the adhesive 117 on the inner face 119a of the second layer 530 and the adhesive 117 on the inner face 119a of the first layer 510. The strip of transparent adhesive 120 extends along the first layer 510 opposite the sheet 520 where the first and second layers 510, 530 of the transparent laminate 119 are coupled directly together (i.e., coupled together without separation by the material 111), and the backing 122 is coupled to the adhesive 120 to temporarily conceal the adhesive 120. A plurality of the supplemental labels 110 are distinctly defined by the described composition, such as through a cutting step as discussed further below, and each supplemental label 110 may be easily separated from each other supplemental label 110.

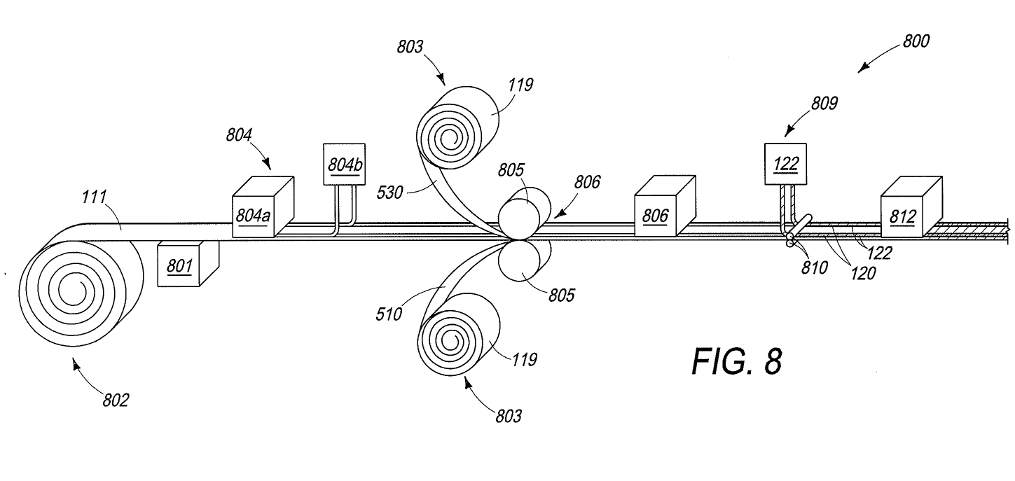

FIG. 8 shows a manufacturing process 800 according to an embodiment that may be used to create the sheets 500 of the supplemental labels 110. At a first station 801, indicia may be printed upon the material 111, such as through a laser printer, a dot-matrix printer, or another printing device. The material 111 may be provided as one or more roll 802 capable of being separated into many sheets 520, or sheets 520 of the material 111 may be used. As the transparent laminate 119 may provide a surface that cannot be easily or economically printed upon, it may be important to print all desired indicia on the material 111 at station 801 or at least before the material 111 is introduced to the laminate 119 as described below. In other words, the indicia may be printed on the material 111 in a process separate from (and prior to) process 800.

At a station 804, a cutting tool 804a may cut the material 111 and a vacuum 804b or another suitable device may then separate and remove the cut material from the remainder of the material 111. This may provide the spacing between the material 111 (i.e., at the coupling portions 115) as discussed above.

At a station 806, the first and second layers 510, 530 of the transparent laminate 119 may be coupled to the material 111 using the adhesive 117 and conventional press equipment (e.g., rollers 805). The transparent laminate 119 may be provided as rolls 803, for example. The laminate 119 may be coupled to the material 111 so that the material 111 is spaced along the laminate 119 to maintain the spacing between the material 111 (i.e., at the coupling portions 115).

At a station 809, the transparent adhesive 120 and the backing 122 may be introduced to the first layer 510 of the transparent laminate 119. Conventional press equipment, such as rollers 810, may be used in coupling the adhesive 120 and the backing 122 to the laminate 119. The backing 122 and the adhesive 120 may be coupled to the first layer 510 of laminate 119 in a single step as shown in FIG. 8, or through multiple steps. The adhesive 120 and the backing 122 may be coupled to the laminate 119 at the spacing between the material 111 (i.e., at the coupling portions 115).

At a station 812, a cutting tool may cut through the material 111, the clear laminate 119, the adhesive 120, and the backing 122 to define a plurality of the supplemental labels 110 so that the individual supplemental labels 110 can be separated from one another. If the material 111, the transparent laminate 119, and/or the backing 122 is provided in rolls, the cutting tool at station 812 or another cutting tool (not shown) may separate the material 111, the laminate 119, the adhesive 120, and the backing 122 into the sheets 500 of the supplemental labels 110.

Returning to FIG. 4, a respective supplemental label 110 may be separated from a respective sheet 500 (FIG. 5) and coupled to the store shelf 30 over the other label 32 using the adhesive 120 exposed by removing the backing 122. Because of the transparency of the coupling portion 115 (i.e., the clear laminate 119 and the adhesive 120), the other label 32 may still be viewed. Because the other label 32 may still be viewed, a customer can easily make comparisons between information on the supplemental label 110 and the other label 32, and there is no need for a product's barcode or other static data to be printed on the supplemental label 110. For example, a customer may see an original price on the other label 32 and a sale price on the supplemental label 110 and feel confident that the price has been lowered. Once the supplemental label 110 is no longer needed (e.g., a sale is over), the supplemental label 110 may be separated from the shelf 30 and leave and the other label 32 intact. To do this, it is important that the adhesive 120 is not too aggressive. However, the adhesive 120 must be strong enough to couple the transparent laminate 119 to the shelf 30 as desired. Perforations 129 may be included generally between the coupling portion 115 and the presentation portion 112 as shown in FIG. 4 to allow the presentation portion 112 to be separated from the coupling portion 115. As such, the presentation portion 112 may be separated from the coupling portion 115 and the shelf 30, and the coupling portion 115 may remain over the other label 32.

Those skilled in the art appreciate that variations from the specified embodiments disclosed above are contemplated herein and that the described embodiments are not limiting. The description should not be restricted to the above embodiments, but should be measured by the following claims.

1. A supplemental label for removable attachment to an object, the supplemental label comprising:
a presentation portion having a front face including indicia;
a coupling portion extending from the presentation portion and having opposed front and rear faces; and
transparent adhesive adhered to the coupling portion rear face to removably couple the coupling portion to the object;
wherein:
the presentation portion includes a first material; and
first and second sheets of transparent laminate sandwich the first material and comprise the coupling portion.

2. The supplemental label of claim 1, further comprising a backing removably concealing the transparent adhesive adhered to the coupling portion rear face.

3. The supplemental label of claim 1, wherein the transparent adhesive is adhered directly to the coupling portion rear face for selectively coupling the coupling portion to the object.

4. The supplemental label of claim 1, wherein the first and second sheets of transparent laminate entirely encase the first material.

5. The supplemental label of claim 1, wherein:
the first sheet of laminate has an inner face with transparent adhesive;
the second sheet of laminate has an inner face with transparent adhesive; and
the adhesive on the inner faces of the first and second sheets of laminate couples the first and second sheets of laminate to the first material at the presentation portion and couples the first sheet of laminate to the second sheet of laminate at the coupling portion.

6. The supplemental label of claim 1, wherein:
the first sheet of laminate includes an inner face having transparent adhesive coupling the first sheet of laminate to the first material and the second sheet of laminate; and
the second sheet of laminate includes an inner face having transparent adhesive coupling the second sheet of transparent laminate to the sheet of material and the first sheet of laminate.

7. The supplemental label of claim 6, wherein the first sheet of transparent laminate coupled to the second sheet of transparent laminate beyond the first material defines the coupling portion front and rear faces.

8. The supplemental label of claim 1, wherein the first material is a paper material capable of receiving printed indicia thereon.

9. The supplemental label of claim 1, wherein:
the presentation portion has an end adjacent the coupling portion;
the coupling portion has opposed sides; and
the coupling portion sides are unbounded beyond the presentation portion end.

10. The supplemental label of claim 1, wherein:
the presentation portion has opposed ends and opposed sides that collectively define a generally rectangular shape;
the coupling portion has opposed ends and opposed sides that collectively define a generally rectangular shape having a width approximately equal to a width of the presentation portion rectangular shape;

11. The supplemental label of claim 1, wherein the transparent adhesive is a pressure-sensitive adhesive.

12. The supplemental label of claim 1, wherein:
the object is a display having a label; and
the coupling portion is sized to cover the label.

13. A method of manufacturing a supplemental label, comprising:
providing a first material;
providing a first sheet of laminate having an inner face with transparent adhesive and an outer face;
providing a second sheet of laminate having an inner face with transparent adhesive and an outer face;
completely encasing the first material between the first and second sheets of laminate, whereby the adhesive on the first sheet of laminate couples the first sheet of laminate to the first material and to the second sheet of laminate and whereby the adhesive on the second sheet of laminate couples the second sheet of laminate to the first material and to the first sheet of laminate;
introducing a pattern of transparent adhesive to one of the first sheet of laminate outer face and the second sheet of laminate outer face for selectively coupling the first material, the first sheet of laminate, and the second sheet of laminate to an object when exposed;
removably coupling a backing to the pattern of transparent adhesive for selectively concealing the pattern of transparent adhesive.

14. The method of claim 13, further comprising the step of perforating the first material, the first sheet of laminate, and the second sheet of laminate to define a plurality of supplemental labels.

15. The method of claim 13, wherein the first material includes indicia.

16. The method of claim 13, further comprising the step of printing indicia on the first material.

17. The method of claim 13, wherein:
the first material is provided in strips; and
the strips of first material are spaced apart between the first and second sheets of laminate that completely encase the first material.

18. A method of manufacturing a supplemental label, comprising:
providing a first material;
providing first and second sheets of laminate, each sheet of laminate having an inner face and an outer face;
completely encasing the first material between the first and second sheets of laminate;
coupling a portion of the first sheet of laminate extending beyond the first material to a corresponding portion of the second sheet of laminate extending beyond the first material to form a coupling portion;
introducing a pattern of transparent adhesive to one of the first sheet of laminate outer face and the second sheet of laminate outer face at the coupling portion to selectively couple the first material, the first sheet of laminate, and the second sheet of laminate to an object; and
removably coupling a backing to the pattern of transparent adhesive for selectively concealing the pattern of transparent adhesive.

19. The method of claim 18, further comprising the step of perforating the first material, the first sheet of laminate, and the second sheet of laminate to define a plurality of supplemental labels.

20. The method of claim 18, further comprising the step of printing indicia on the first material.
